(19) United States
(12) Patent Application Publication
(10) Pub. No.: US 2014/0146296 A1
(43) Pub. Date: May 29, 2014

(54) PROJECTOR

(71) Applicants: HONG FU JIN PRECISION INDUSTRY (ShenZhen) CO., LTD., (US); HON HAI PRECISION INDUSTRY CO., LTD., New Taipei (TW)

(72) Inventors: BO TIAN, Shenzhen (CN); YU HAN, Shenzhen (CN); KANG WU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/721,038

(22) Filed: Dec. 20, 2012

(30) Foreign Application Priority Data
Nov. 23, 2012 (CN) 2012104808475

(51) Int. Cl. G03B 21/14

(52) U.S. Cl. CPC G03B 21/142; G03B 21/145
USPC 353/101; 353/100

(57) ABSTRACT

A projector includes a projector body, a mount fixed to a top of the projector body, and a projector lens assembly rotatably mounted to a top of the mount and electrically connected to the projector body. An inputting module and a processor are arranged in the projector body. A light source, a light engine, and a lens are arranged in the projector lens assembly. The inputting module receives image data and sends the image data to the processor. The processor creates instructions according to the image data. The projector lens assembly projects an image which reflects the image data, according to the instructions.

### BACKGROUND

1. Technical Field

The present disclosure relates to a projector.

2. Description of Related Art

Projectors, such as digital projectors, have become more versatile and can project images onto almost any nearby flat surface. However, although a variety of surfaces may be suitably used as projection surface, configurations of those projectors still require that the projector be arranged to directly point at the projection surface and to be within a certain distance of the surface, which is inconvenient in many circumstances.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a projector.

FIG. 2 is an assembled, isometric view of FIG. 1.

FIG. 3 is a block diagram of the projector of FIG. 2.

### DETAILED DESCRIPTION

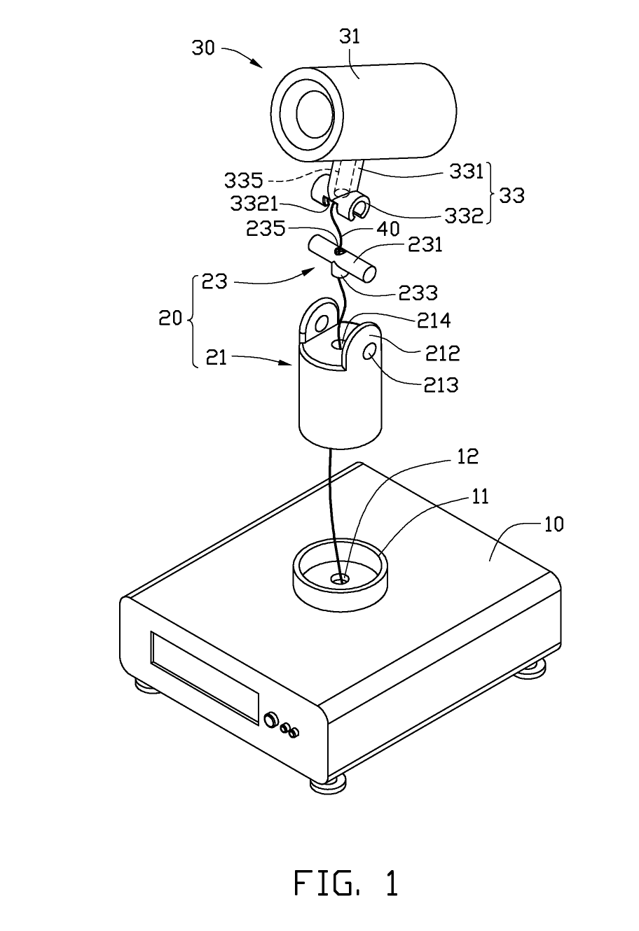

Referring to FIG. 1, an embodiment of a projector includes a projector body 10, a mount 20, and a projector lens assembly 30.

An annular positioning portion 11 is centrally fixed on a top of the projector body 10. A through hole 12 is defined in the top of the projector body 10 aligned in the center of the positioning portion 11.

The mount 20 includes a columnar supporting member 21 and a T-shaped connection member 23. The supporting member 21 includes opposite tabs 212 extending up from a top of the supporting member 21. Each of the tabs 212 defines a fixing hole 213. The supporting member 21 axially defines a receiving hole 214 extending through the top of the supporting member 21. The connection member 23 includes a first connection pole 231 and a second connection pole 233 perpendicularly extending down from a middle of the first connection pole 231. The connection member 23 defines a receiving hole 235 along an axis of the second connection pole 233 and extending through the first and second connection poles 231 and 233.

The projector lens assembly 30 includes a columnar main body 31 and a linking member 33. The linking member 33 includes a pivotal portion 332 defining a C-shaped cross section and a shaft 331 connected between a middle of the pivotal portion 332 opposite to an opening of the pivotal portion 332 and a side of the main body 31. An interference-avoiding notch 3321 is defined in a side of the pivotal portion 332, aligned with the shaft 331, and adjacent to the opening of the pivotal portion. The projector lens assembly 30 defines a receiving hole 335 extending along an axis of the shaft 331, the receiving hole 335 extending through the side of the main body 31, the shaft 331, and the pivotal portion 332.

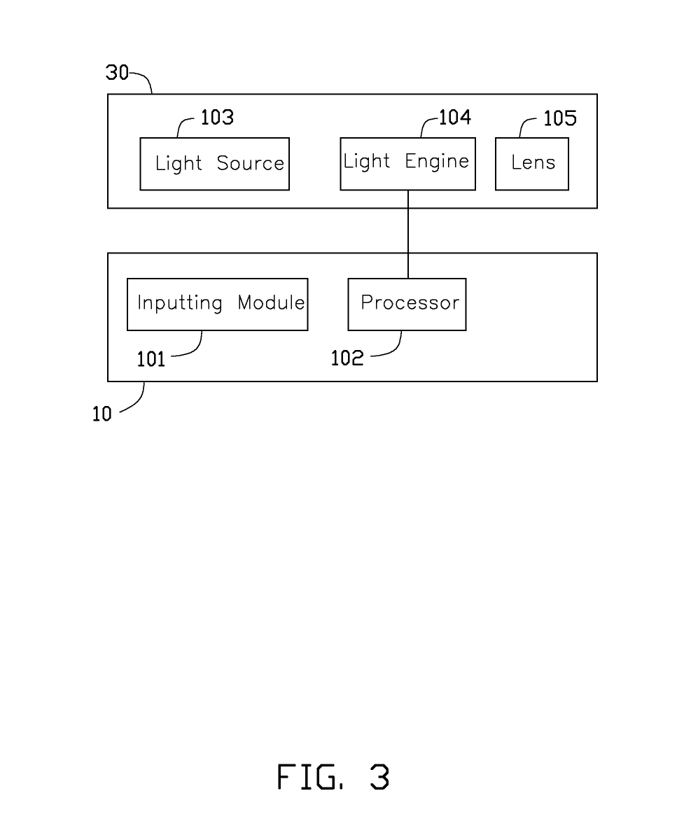

Referring to FIG. 3, an inputting module 101 and a processor 102 are arranged in the projector body 10. A light source 103, a light engine 104, and a lens 105 are arranged in the projector lens assembly 30. In use, the inputting module 101 receives image data and transfers the image data to the processor 102. The processor 102 creates instructions according to the image data and transfers the instructions to the light engine 104. The light engine 104 executes the instructions to form an image, which reflects the image data, using light from the light source 103, and projects the image through the lens 105.

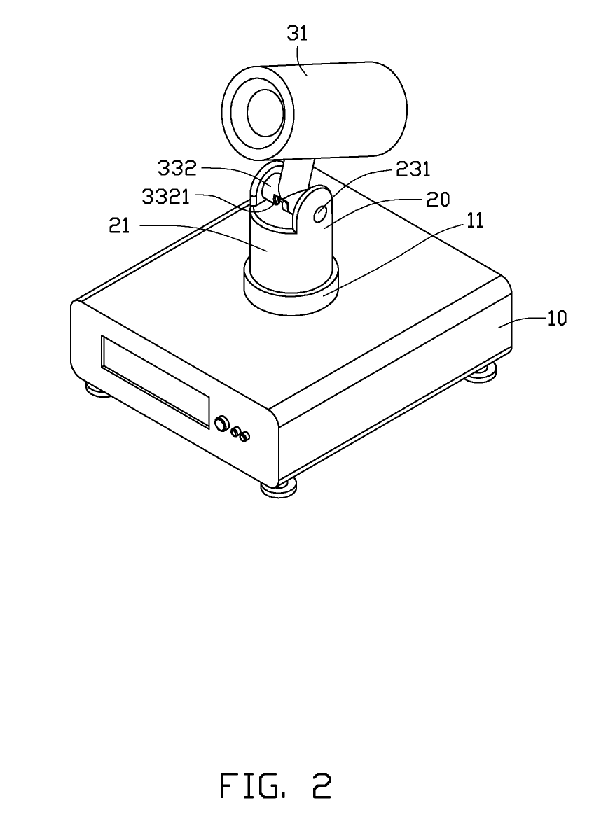

Referring to FIG. 2, in assembly, a lower portion of the supporting member 21 of the mount 20 is received in the positioning portion 11. The receiving hole 214 of the supporting member 21 is aligned with the through hole 12 of the projector body 10. The connection member 23 is secured to the top of the supporting member 21, with opposite ends of the first connection pole 231 respectively fixed in the fixing hole 213 of the two tabs 212, and the second connection pole 233 fixed in the receiving hole 214. The pivotable portion 332 of the projector lens assembly 30 is rotatably sleeved on the first connection pole 231 to rotatably connect the projector lens assembly 30 to the projector body 10 through the mount 20. The second connection pole 233 is adapted to be engaged in the interference-avoiding notch 3321 to prevent the second connection pole 233 from interfering with the pivotal portion 332 in rotation. The receiving hole 335 of the projector lens assembly 30 is aligned with the receiving hole 235 of the connection member 23 to enable a cable 40 connected between the projector body 10 and the projector lens assembly 30 to extend through the receiving holes 335, 235, and 214, and the through hole 12 of the projector body 10. The projector lens assembly 30 can be positioned at a desired projection angle due to a friction force between the pivotal portion 332 and the first connection pole 231.

It is to be understood, however, that even though numerous characteristics and advantages of the present disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A projector, comprising:
a projector body comprising an inputting module to receive image data and create instructions according to the image data;
a mount fixed to a top of the projector body; and
a projector lens assembly rotatably connected to a top of the mount and electrically connected to the projector body, the projector lens assembly comprising a light source, a lens, and a light engine executing the instructions to form an image, which reflects the image data, using light from the light source, and projecting the image through the lens.

2. The projector of claim 1, wherein the mount comprises a supporting member and a connection member fixed to a top of the supporting member, the connection member comprises a first connection pole, the projector lens assembly comprises a pivotal portion rotatably sleeved on the first connection pole.

3. The projector of claim 2, wherein the projector body defines a through hole in the top of the projector body, the supporting member defines a receiving hole extending through the top of the supporting member, the connection member defines a receiving hole aligned with the receiving hole of the supporting member, the projector lens assembly defines a receiving hole aligned with the receiving hole of the connection member to enable a cable connected between the projector body and the projector lens assembly to extend through the receiving holes of the projector lens assembly, the connection member, the supporting member, and the through hole of the projector body.

4. The projector of claim 2, wherein an annular positioning portion protrudes on the top of the projector body, the supporting member is columnar, and a lower portion of the supporting member is fixed in the positioning portion.

5. The projector of claim 2, wherein the supporting member comprises opposite tabs extending up from the top of the supporting member, each of the tabs defines a fixing hole, opposite ends of the first connection pole of the connection member are respectively fixed in the fixing holes of the tabs.
